(19) United States
(12) Patent Application Publication
(10) Pub. No.: US 2008/0133516 A1
(43) Pub. Date: Jun. 5, 2008

(54) Method and system for dynamic matching or distribution of documents via a web site

(76) Inventor: Oded Itzhak, Hoboken, NJ (US)

Correspondence Address: Pearl Cohen Zedek Latzer, LLP, 1500 Broadway, 12th Floor, New York, NY, 10036, US

(21) Appl. No.: 11/657,547

(22) Filed: Jan. 25, 2007

Related U.S. Application Data
(60) Provisional application No. 60/872,783, filed on Dec. 5, 2006.

(51) Int. Cl. G06F 17/30

(52) U.S. Cl. 707/6

(57) ABSTRACT

A method and system may distribute documents relevant to a website to that website. A server may receive a request from a web page of a web site for documents relevant to the web page. The server may search for documents based on for example relevancy to the web page, transmit the documents to the website, and the documents may be displayed at the website. Display of the documents may not cause redirection away from the website.

### PRIOR APPLICATION DATA

The present application claims the benefit of prior U.S. provisional application Ser. No. 60/872,783, filed Dec. 5, 2006, entitled “METHOD AND SYSTEM FOR DYNAMIC MATCHING OR DISTRIBUTION OF DOCUMENTS VIA A WEB SITE,” incorporated by reference herein in its entirety.

### FIELD OF THE INVENTION

The present invention relates to methods and systems for matching related or relevant third-party documents to web pages.

### DESCRIPTION OF THE DRAWINGS

Specific embodiments of the present invention will be described with reference to the following drawings, wherein:

FIG. 1 is a simplified block diagram of a system for dynamic matching or syndication of web content in accordance with some exemplary embodiments of the invention.

FIG. 2 is a flowchart showing a method for matching or syndicating web content in accordance with some exemplary embodiments of the invention.

FIG. 3 is a flowchart showing a method for matching or syndicating web content in accordance with some exemplary embodiments of the invention.

### SUMMARY

A method and system may, in one embodiment, distribute documents relevant to a website to that website. In one embodiment, a server may receive a request from a web page of a web site for documents relevant to the web page. The server may search for documents based on for example relevancy to the web page, transmit the documents to the website, and the documents may be displayed at the website. In some embodiments, display of the documents does not cause redirection away from the website.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention include a system and method for dynamically matching, linking or distributing third-party documents to or in web pages based on, for example, the textual information or subject information on the web pages, and in addition for syndicating or distributing those documents for display oil the web pages. In some embodiments, the publisher of a web page's content may enroll in advance with a service or server to provide the matching and possibly receive code, a plug-in, or a link for incorporation into or use with the web page that enables the web page to retrieve related documents from a separately hosted application.

When used herein, a document may include, for example, content from a web page or website, journalized web site entries (e.g., “blogs”), or a document such as a paper, article, whitepaper, news story, encyclopedia entry, or other document, a file, an image, an audio or video recording, or other types of documents. In the case of an image, video or audio based document, textual information may be associated with the document (e.g., in a title, description, or set of keywords); this textual information may be searched or analyzed as with more traditional documents. While a user's interface with a computer or website is often discussed herein with respect to mouse clicks on a web page, other methods of interaction may be used, such as keyboard interaction, or interaction via other pointing devices.

In one embodiment, a system or method may distribute a document to a web page, by, e.g., transmitting a request for a document from web site configured to allow a document to be viewed within the website, e.g., without redirecting the end-user to an external web site, or to a web page outside the website, searching a database of documents for at least one document based on relevancy to the web site, transmitting the at least one document to the web site for retrieving and viewing web content; and displaying the at least one document by the web site.

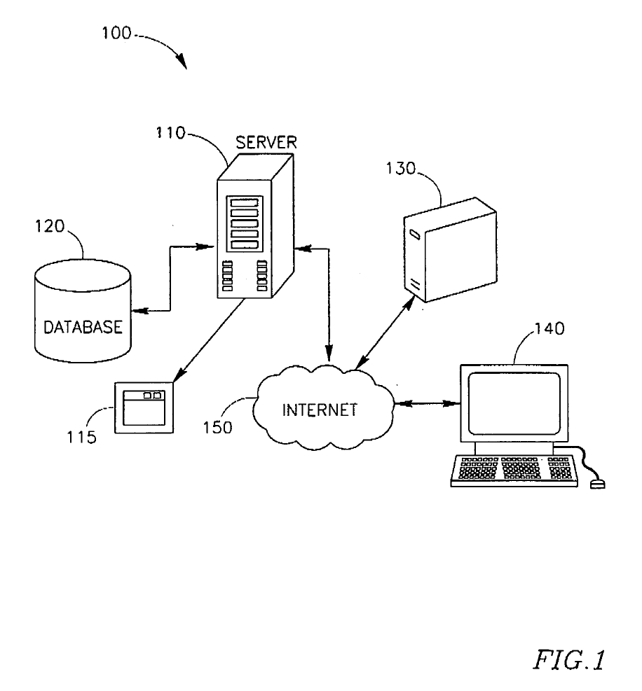

FIG. 1 depicts a simplified block diagram of a system for dynamic matching or distribution of content over the World Wide Web (“Web”) in accordance with an embodiment of the present invention. System 100 may include a server 110 for hosting or executing a document matching and distribution system or service, an associated database 120, a web host 130, and a user workstation 140 connected to a public network 150, which may be for example the Internet Server 110 may be or include any computer capable of hosting a process as disclosed herein, and applications for interacting with web publishers and users. Some embodiments of the present invention may include an application capable of generating code or plug-ins in a programming language compatible with incorporation on certain websites, such as, for example, in JavaScript. This application may also be capable of interacting with browsers or other applications for retrieving and viewing web content.

Database 120 may be or include any software process or application for storing and retrieving data, files, or a plurality of documents, such as a database system such as, e.g., a relational database. Documents stored in the database may include content on a broad variety of subject matter. In alternate embodiments documents provided by server 110 to client websites may not be located in database 120. In some embodiments of the present invention, one or more of these documents may be protected under copyright or other laws, and/or may be licensed to permit royalty-free distribution and publication on commercial web sites, such as e.g., the GNU Free Documentation License and CreativeCommons licenses. For other embodiments, distribution of one or more of the documents may be governed by other laws or licensing arrangements, for example directly or indirectly with the content owner, possibly for financial consideration.

Some embodiments may also include a software agent 115 to find and/or collect documents for matching, distribution syndication, retrieval, indexing and storage in database 120. Software agent 115 may be hosted on any computer capable of running a software agent at a location with access to the web such as, e.g. server 110. Software agent 115 may methodically search the web for documents and may include a web crawler or other software agent well known in the art. Indexing by agent 115 may also include creation of data structures such as for example an inverted table that allows for quick document retrieval based on a page vector, e.g. a list of terms or phrases constructed algorithmically to represent the content of a web page.

Articles or documents may be input to database 120 via routes other than agent 115. For example, some embodiments may include a software tool for content owners to incorporate their content into database 120 at their convenience or when published. In such a manner searching database 120 may search a website of an owner; alternately the website of the owner may be searched without having its content input into a database. As another example, some embodiments may include software for searching for and/or including content from other pages on the publisher's web site. Furthermore, some embodiments may limit content to that collected by a single content owner. In these instances, the content owner may be able to syndicate its content as a private label system. Embodiments may allow for only content from the web site being viewed to be linked based on relevance; in such a case no other content would be viewed by the user.

Web host 130 may be or include any computer or computer system capable of hosting a web site, typically composed of individual web pages, as is commonly known in the art. Each web page may be written in Hypertext Markup Language (HTML) or other suitable language as is known. A web page may also include one or more frames for displaying additional content not present on the web page.

A user may access web host 130 via for example workstation 140 which may be for example any general purpose computer capable of supporting any application for retrieving and viewing web content, or any other suitable device such as a cell phone, personal digital assistant (PDA), video game console, etc. Although not limited in this respect, some embodiments of the present invention may incorporate a web browser as an application for retrieving and viewing web content. Such web browsers may retrieve content from the web in a client-server dialogue of requests from the browser and responses from the web site.

Public network 150, which connects server 110, web host 130 and workstation 140, may be any publicly accessible network such as the Internet. Access to public network 150 may be through wire line, terrestrial wireless, satellite or other systems well known in the art.

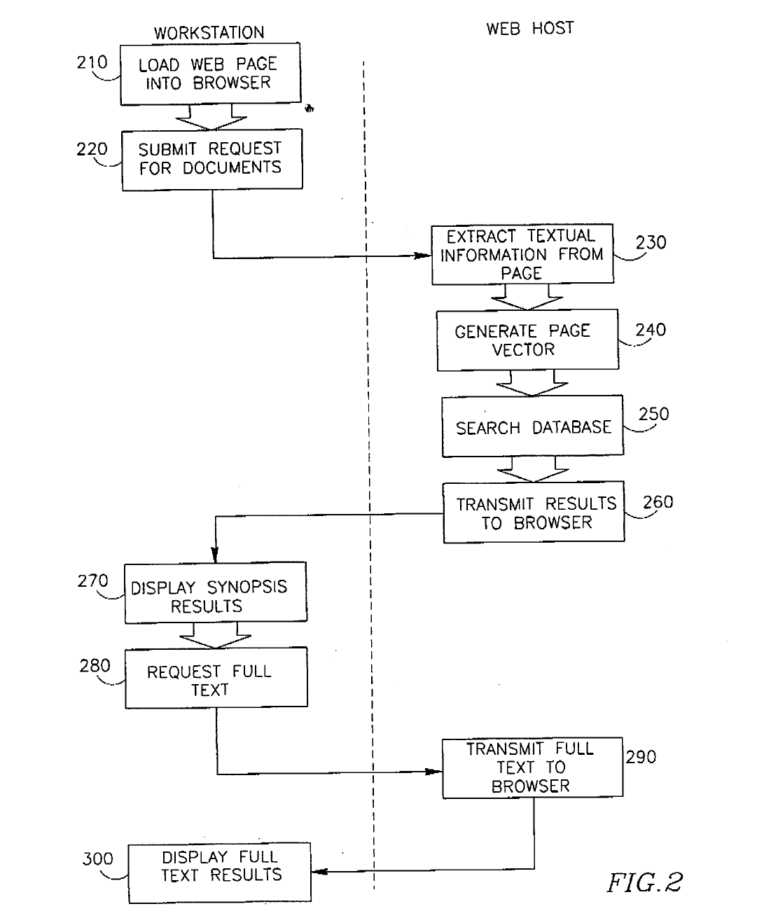

Reference is now made to FIG. 2, which is a simplified flowchart illustration of a method for matching or distribution of web content in accordance with some exemplary embodiments of the present invention. While operations are assigned to a web-host or workstation, as described herein, in other embodiments the operations may be performed by different entities, having different structures. Furthermore, other or different operations may be performed.

A user may load a web page from a web site with a web browser on workstation 140 from web host 130 transmitted over public network 150 (operation 210). Methods and devices for viewing content and documents, other than a web page and browser may be used. The web page may include, for example, added code or a plug-in, for transmitting a request for documents related to the content of the web page, and possibly for receiving and displaying such content Such code may be generated for example manually or automatically. For example, such code may be generated by a self-service tool or software agent. Such code may be incorporated in the web page for example manually or automatically. For example, such code may be inserted by a self-service tool or software agent for use by web site owners that inserts the code as part of, for example, an enrollment process. A web site owner may connect to server 110, which may provide code or a plug-in to be inserted in the web site. In some embodiments, the code for transmitting a request for documents may be in the form of JavaScript or other suitable code as in known in the art for performing a second call to server 110. Other well known means for effecting or triggering requests for documents may be utilized without departing from the scope of the present invention.

In some preferred embodiments, the web page or site publisher may receive the code for transmitting a request for documents as part of an enrollment process to, for example, a service operated or hosted by server 110. During this enrollment process, the publisher may also be asked to define the properties or parameters associated with the document retrieval, or a search. These properties or parameters may include, but are not limited to look and feel attributes of the documents, source channels for the documents, document lengths, content categories, documents or categories to exclude, and other document properties. For example, a publisher may select documents from a News category and additionally select Reuters, Associated Press, and US Today as content sources for News. In addition, the publisher may also pre-select specific documents for retrieval. Properties or parameters associated with the document retrieval may be defined by a publisher at a later time, for example uniquely for each page published by the publisher.

The contents of the request may include any parameters or information, such as descriptive information, that describe the web page, user or client including, but not limited to, for example: a customer or user ID, a client identification code, a security code, the URL of the web page, a list of keywords or metadata from the web page as is known in the art, and/or content from the web page. The request may include properties or parameters defining the search for documents relevant to the web site.

In operation 220, the request for related documents may be submitted to for example a server for example operating a method according to an embodiment of the present invention via, for example, public network 150. Upon receipt of the request, the server may extract or determine the subject or content of the web page, or extract words and phrases from the published web page that may best represent the content of the page. In some embodiments, if the request includes the URL of the web page, the server may download the page and extract textual information directly from the page. In other embodiments, the server may extract information representing the web page in advance of receiving the request, for example, during an enrollment process.

The server may calculate and assign weightings for some terms and/or phrases based on, for example, the respective term and/or phrase appear within the page and may subsequently select words and/or phrases whose weight exceeds a threshold while discarding those that may not bear on the threshold. In some embodiments, “stop words” or other terms may be ignored. Text mining methods such as “tf-idf” weight (term frequency-inverse document frequency) may be used. Other summary or text-mining methods may be used.

One factor for determining weighting may be the frequency with which a term or phrase appears on the web page. Other methods as are known in the art for determining the weights of terms and phrases may also be employed such as a term frequency-inverse document frequency (TF-IDF) weighting scheme. In other embodiments, the server may use the page content or a keyword list included with the request without further weighting. In other embodiments, a weighted list of terms and phrases may already be included in the request. Other methods of extracting and weighting words and phrases may be used. In some embodiments, the page vector for a particular URL may be retrieved from a cache or a database if such page vector had been previously generated for the URL.

Once the server has identified a list of terms and or phrases associated with the web page, the application may construct a page vector consisting of the terms and or phrases on the list as weighted (operation 240). Database 120 may be searched for documents relevant to the requesting web page (e.g., related to the page vector) using one or more relevancy methods as known in the art for determining inter-document similarity (operation 250). These methods may include, but are not limited to cosine measures, latent semantic analysis and other information retrieval techniques.

Additionally, the server may also screen relevancy of documents by one or more limitations or parameters previously defined by the web site's publisher. The results of the search may be one or more documents that have some contextual relevance to the content of the web page as determined by the search.

In operation 260, results of the search may be transmitted to the web page on workstation 140 for display to the user within the web site. In some embodiments the transmitted results may include the full contents of each document included in the search result. For example, the web page may include one or more appended or inserted documents, and a user may not need to separately request the documents. In some embodiments the transmitted results may include a list or a set of synopses of documents included in the search result or enough information to display the subject matter of each document included in the search result such as, for example, a title, a synopsis and or other conventional summary information in, for example, list form. Other methods of displaying results, such as thumbnails or images, may be used. E.g., a video or image document may be listed along with a thumbnail image. Additionally, the information on each document may include a link that, when clicked on or followed by a user, may allow the user to view the entire document. The display may be in the form of a frame on the web page, a new window, writing the content into the web page using client-side scripting language, or other form as known in the art. The display may also include conventional tools for navigating a set of documents that is longer than the available space or that may be organized into different categories for the display. For example, the navigational tools may include tabs and scroll bars.

If the user is interested in one or more of the displayed documents, the user may select a document by clicking on or otherwise selecting (e.g., via a keyboard) the link associated with that document. For search results in the current state of the art, such a link typically redirects the user to another web site containing the results of the search that may or may not be familiar to the user. In such instances in which this link is associated with an advertisement, clicking on a link may also result in a fee paid by the advertiser to the web site publisher and the advertisement insertion provider. In one embodiment of the present invention, rather than the link redirecting the user to another web site containing the results of the search (that may or may not be familiar to the user, and may not be under the control of the first web page controlled by the client or publisher), the user may be enabled to view the results of the search within the web site and possibly without any fees being charged. When, for example, the user clicks on a document link or takes another action to select the document, or another event occurs, the web browser may submit a request for the full text to the server (operation 280).

In response, the application then may transmit some portion or all of the full text and/or other content (e.g. images, video, audio) to the browser in operation 290. Transmitting the document may include transmitting the full content of the document—e.g., the full text, the full video content, etc. Only a portion of the content may be transmitted. Advertisements or other information may be transmitted with the document. The browser may display the full text (operation 300) for the user on the web site, although in some embodiments the browser may be redirected to another web site. Rather than transmit the full text, some portion of the text or other content may be transmitted to the browser as needed by the user. In some embodiments the document display may be in another web page under the same web domain, in a floating window or frame, or in the same frame in which the original search results were displayed. Other display techniques for showing a text document without leaving or being redirected away from a web site may also be used.

In some embodiments where only a portion of the full text is displayed after a user clicks on a document link, a further action may be required, such as, e.g., clicking on another link, to obtain the full text of the article. Such an additional link may direct the browser to an external web site that shows the entire article or may trigger a further request to server 110 for the full text of the article.

For revenue generating purposes, some embodiments of the present invention may include inserting one or more advertisements into the body of the displayed document or into the first displayed search results. The assignment of such an advertisement may be achieved through any conventional method as known in the art. Revenues derived from the display of such advertisements may then be shared between the application service provider (e.g., the operator of the server), the content owner and the web site. Other revenue sharing arrangements are also possible without departing from the scope of the present invention. In some embodiments, the revenue sharing can be achieved by allocating a percentage of advertisement impressions to each party according to a predetermined revenue split. For example, it can be determined that the web site is entitled to 60% of the advertisement impressions and the service provider is entitled to 40%. In such case, 60% of the advertisement codes injected into the content body will be of the web site. Other proportions or methods may be used.

Furthermore, in some embodiments the user may be given the opportunity to rate the quality of the document according to a scoring system. For example, users may be enabled to evaluate documents on one or more bases such as e.g., their interest level or value utilizing a rating system such as, e.g., a 0 to 5 scale. Other rating systems may be used.

Collecting user ratings on documents may be accomplished by any suitable method. For example, a JavaScript process on the web page may direct a user's submitted rating to the server 110. A collection of user ratings for documents may be incorporated into the document database and document matching process as a secondary sorting parameter for determining what results to display on the web site. Furthermore, some embodiments may also include other measures of the documents' utility to users as an additional secondary sorting parameter for the document matching process such as, e.g., the click through rate of the documents as determined by, for example, the number of users clicking on an article to view it divided by the total number of times it was displayed on all web pages served by the present invention.

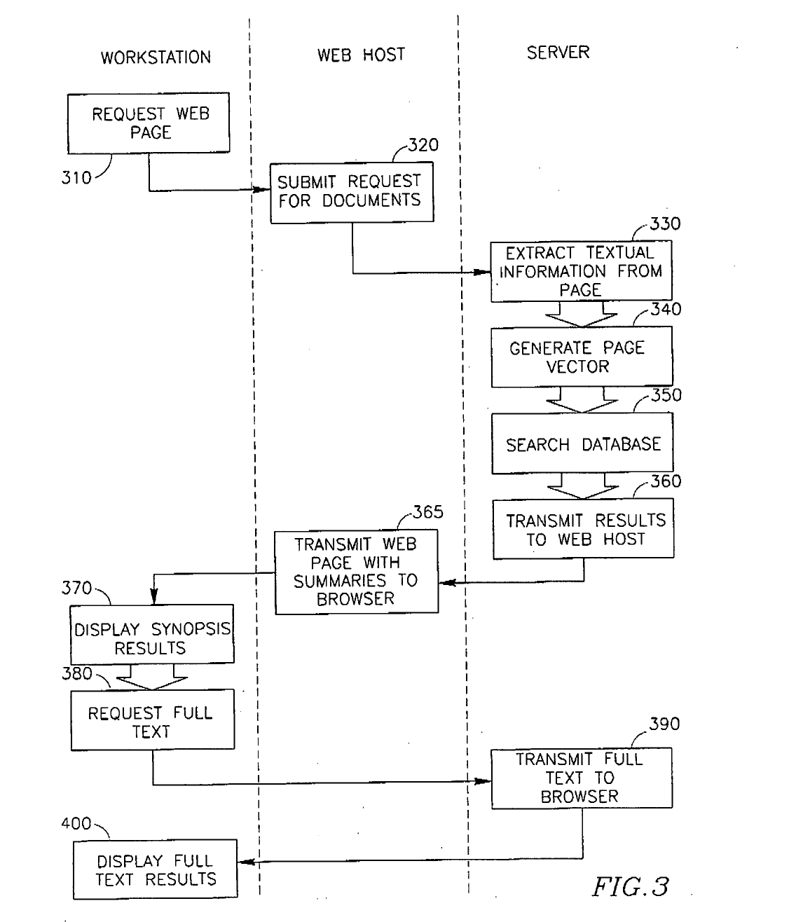

Reference is now made to FIG. 3 which is a simplified flowchart illustration of a method for matching or distribution of web content in accordance with some exemplary embodiments of the present invention. While operations are assigned to a web-host, workstation, or a server, as described above, in other embodiments the operations may be performed by different entities, or entities having different structures. Furthermore, other or different operations may be performed.

In operation 310, a user may request a web page with a web browser on workstation 140 from web host 130 transmitted over public network 150. In operation 320, web host 130 may respond by submitting a request for documents related to the content of the web page such as that described above for operation 220 to for example a server operating a method according to an embodiment of the present invention via, for example, public network 150.

For some embodiments, operations 330 to 350 may proceed as described for operations 230 to 250. However, in operation 360 results of the search may be transmitted back to web host 130. Web host 130 may merge the search results with the web page and may transmit the merged results to the browser on work station 140 (operation 365). In some embodiments, the transmitted results may be as described for operation 260. Subsequent operations 370 through 400 may proceed as described for operations 270 through 300.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

What is claimed is:

1. A method for distributing a document, the method comprising:
accepting at a server a request from a web page of a web site for a document relevant to the web page;
searching for a document based on relevancy to the web page;
transmitting the document to a web browser; and
displaying the document at the web browser within the web site.

2. The method of claim 1 wherein said server hosts an application for searching a database of documents.

3. The method of claim 1 wherein searching comprises searching a database of documents from the web site.

4. The method of claim 1 wherein searching comprises searching a database of documents.

5. The method of claim 1 comprising collecting documents for incorporation into the database of documents.

6. The method of claim 1 comprising defining parameters for searching a database of documents and associating the parameters with the web site.

7. The method of claim 1 comprising defining parameters for searching a database of documents and including the parameters in the request.

8. The method of claim 1 wherein said request for a document relevant to the web page comprises descriptive information regarding the web page.

9. The method of claim 1 wherein transmitting the document comprises transmitting the full content of the document.

10. The method of claim 1 wherein transmitting the document comprises transmitting an advertisement with the document.

11. The method of claim 1 wherein displaying the document does not cause redirection away from the web site.

12. The method of claim 11 further comprising accepting a rating for the document, the rating being according to a quality scoring system.

13. The method of claim 1 wherein the request from a web page is transmitted by code added to the web page.

14. The method of claim 13 wherein the code is JavaScript code.

15. The method of claim 13 wherein the code is generated automatically by a software agent.

16. A server for accepting a request from a web page of a web site for a document relevant to the web page, searching for a document based on the relevancy to the web page, and transmitting the document to a web browser for viewing within the web site.

17. The server of claim 16, wherein the server hosts an application for searching a database of documents based on relevance to a web page.

18. The server of claim 16 wherein the server collects documents for incorporation into the database of documents.

19. The server of claim 16 wherein the server accepts parameters for searching a database of documents and associating the parameters with the web site.

20. The server of claim 16 wherein said request for a document relevant to the web page comprises descriptive information regarding the web page.

21. A method comprising:
in a web page being executed by a client computer, transmitting a request for documents relevant to the subject matter of the web page to a remote server;
receiving at the web page a set of documents relevant to the subject matter of the web page;
displaying in the web page a list of the documents;
accepting from a user a selection of a document among the documents;
displaying the document within the web page.

22. The method of claim 21, wherein receiving the set of documents comprises receiving the full content of the documents.

23. The method of claim 21, wherein the request for documents includes parameters for searching a database of documents.

24. The method of claim 21, wherein said request for a document relevant to the web page comprises descriptive information regarding the web page.

25. The method of claim 21, wherein receiving the set of documents comprises receiving an advertisement with the set of documents.

26. A method for distributing a document, the method comprising:
submitting from a web host to server a request for a document relevant to the web page when the web page is requested from the web host in response to a request for a web page;
searching a database of documents for at least one document based on relevancy to the web page;
transmitting a document relevant to the web page from the server to the web host;
transmitting the web page and the document relevant to the web page to the web browser; and
displaying the web page and the document relevant to the web page within the web site.

27. The method of claim 26 comprising defining parameters for searching a database of documents and including the parameters in the request.

28. The method of claim 26 wherein said request for a document relevant to the web page comprises descriptive information regarding the web page.

29. The method of claim 26 wherein transmitting the web page and the document comprises transmitting the web page and the full content of the document.

30. The method of claim 26 wherein displaying the document does not cause redirection away from the web site
